(19) United States
(12) Patent Application Publication
(10) Pub. No.: US 2024/0387859 A1
(43) Pub. Date: Nov. 21, 2024

(54) Non-Aqueous Rechargeable Battery and Method for Manufacturing Non-Aqueous Rechargeable Battery

(71) Applicants: PRIMEARTH EV ENERGY CO., LTD., Shizuoka (JP); TOYOTA JIDOSHA KABUSHIKI KAISHA, Aichi-Ken (JP); PRIME PLANET ENERGY & SOLUTIONS, INC., Tokyo (JP)

(72) Inventors: Takaaki Izumoto, Toyohashi-shi (JP); Kentaro Suzuki, Kariya-shi (JP)

(21) Appl. No.: 18/662,917

(22) Filed: May 13, 2024

(30) Foreign Application Priority Data
May 16, 2023 (JP) 2023-080737

(51) Int. Cl. H01M 10/04; H01M 10/0587; H01M 50/103

(52) U.S. Cl. CPC H01M 10/0468; H01M 10/0431; H01M 10/0587; H01M 50/103

(57) ABSTRACT

A non-aqueous rechargeable battery includes an electrode body, a non-aqueous electrolyte solution, and a case. In the electrode body, a cathode sheet and an anode sheet are stacked with a separator arranged in between. The case accommodates the electrode body and the non-aqueous electrolyte solution. A cell compression parameter obtained by dividing a cell compression force, obtained by multiplying a difference of an internal pressure of the case relative to an atmospheric pressure by an area of a flat portion of the electrode body, by a spring constant of the case is in a range of 0.000 to 0.007.

### CROSS-REFERENCE TO RELATED APPLICATIONS

This application is based upon and claims the benefit of priority from prior Japanese Patent Application No. 2023-080737, filed on May 16, 2023, the entire contents of which are incorporated herein by reference.

### BACKGROUND

### 1. Field

The following description relates to a non-aqueous rechargeable battery and a method for manufacturing a non-aqueous rechargeable battery.

### 2. Description of Related Art

Japanese Laid-Open Patent Publication No. 2017-84550 discloses an assembled battery that includes battery cells arranged next to one another and spacers arranged between the battery cells. Each battery cell includes a group of electrodes and a rectangular case. In the electrode group, a cathode and an anode are arranged facing each other with a separator arranged in between. The case accommodates the electrode group. The electrodes are expanded in a stacking direction during charging and/or discharging. The anode plate described in Japanese Laid-Open Patent Publication No. 2017-84550 is harder than the spacer. Thus, when the electrodes are expanded, the spacer, which is softer than the anode plate, deforms to absorb the strain. In the assembled battery (cell) described in Japanese Laid-Open Patent Publication No. 2017-84550, the hardness of the anode plate needs to be set in accordance with that of the spacer.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a non-aqueous rechargeable battery includes an electrode body, a non-aqueous electrolyte solution, and a case. In the electrode body, a cathode sheet and an anode sheet are stacked with a separator arranged in between. The case accommodates the electrode body and the non-aqueous electrolyte solution. A cell compression parameter obtained by dividing a cell compression force, obtained by multiplying a difference of an internal pressure of the case relative to an atmospheric pressure by an area of a flat portion of the electrode body, by a spring constant of the case is in a range of 0.000 to 0.007.

In another general aspect, a method is for manufacturing a non-aqueous rechargeable battery that includes an electrode body, a non-aqueous electrolyte solution, and a case. In the electrode body, a cathode sheet and an anode sheet are stacked with a separator arranged in between. The case accommodates the electrode body and the non-aqueous electrolyte solution. The method includes adjusting a cell compression parameter obtained by dividing a cell compression force, obtained by multiplying a difference of an internal pressure of the case relative to an atmospheric pressure by an area of a flat portion of the electrode body, by a spring constant of the case in a range of 0.000 to 0.007.

Other features and aspects will be apparent from the following detailed description, the drawings, and the claims.

### BRIEF DESCRIPTION OF DRAWINGS

FIG. 1 is a perspective view schematically showing the structure of a battery cell in accordance with an embodiment of a non-aqueous rechargeable battery.

FIG. 2 is a diagram of a partially unrolled electrode body in accordance with the embodiment of the non-aqueous rechargeable battery.

FIG. 3 is a cross-sectional view of the battery cell in accordance with the embodiment of the non-aqueous rechargeable battery.

FIG. 4 is a graph showing an unbound cell thickness and a lithium plating resistance relative to a cell compression parameter in accordance with the embodiment of the non-aqueous rechargeable battery.

FIG. 5 is a table showing examples and comparative examples of the non-aqueous rechargeable battery.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

### Present Embodiment

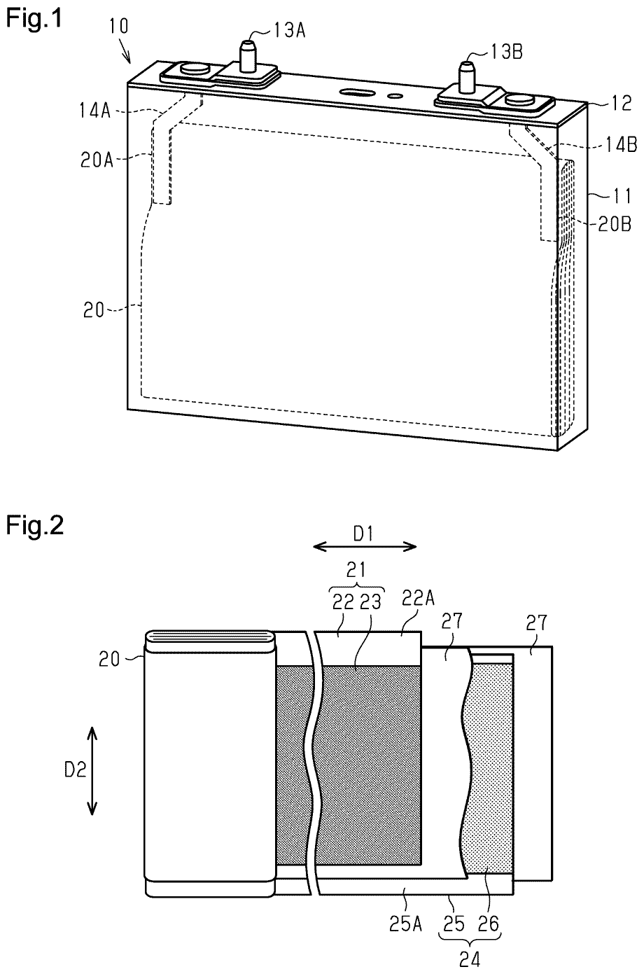

A non-aqueous rechargeable battery and a method for manufacturing a non-aqueous rechargeable battery in accordance with an embodiment will now be described with reference to FIGS. 1 to 4. A lithium-ion rechargeable battery will be described as an example of a non-aqueous rechargeable battery.

### Lithium-Ion Rechargeable Battery 10

As shown in FIG. 1, a lithium-ion rechargeable battery 10 is a battery cell that is combined with other lithium-ion rechargeable batteries 10 and enclosed in a resin case or a metal case to form a battery pack. The battery pack is used in a hybrid electric vehicle or a battery electric vehicle.

The lithium-ion rechargeable battery 10 includes a battery case 11 and a lid 12. The battery case 11 is box-shaped and has an upper opening. The lid 12 closes the opening of the battery case 11. The battery case 11 and the lid 12 are formed from a metal such as aluminum or an aluminum alloy. Attachment of the lid 12 to the battery case 11 forms a sealed battery casing of the lithium-ion rechargeable battery 10.

The lid 12 includes a cathode external terminal 13A and an anode external terminal 13B. The cathode external terminal 13A and the anode external terminal 13B are used to charge and discharge the lithium-ion rechargeable battery 10. The battery case 11 accommodates an electrode body 20. An outer insertion film 15 is inserted between the battery case 11 and the electrode body 20. A cathode current collector portion 20A, which is the cathode end of the electrode body 20, is electrically connected by a cathode current collector member 14A to the cathode external terminal 13A. An anode current collector portion 20B, which is the anode end of the electrode body 20, is electrically connected by an anode current collector member 14B to the anode external terminal 13B. Further, a non-aqueous electrolyte solution is injected into the battery case 11 through an injection hole (not shown). The cathode external terminal 13A and the anode external terminal 13B do not have to be shaped as illustrated in FIG. 1 and may have any shape.

### Electrode Body 20

As shown in FIG. 2, the electrode body 20 is a flattened roll formed by rolling a stack of strips of a cathode sheet 21, an anode sheet 24, and separators 27. The cathode sheet 21, the anode sheet 24, and the separators 27 are stacked so that their long sides are parallel to a longitudinal direction D1. Prior to rolling, the cathode sheet 21, the separator 27, the anode sheet 24, and the separator 27 are stacked in this order.

### Cathode Sheet 21

The cathode sheet 21 includes a cathode current collector 22 and a cathode mixture layer 23. The cathode current collector 22 is a strip of a cathode substrate foil. The cathode mixture layer 23 is applied to each of the opposing surfaces of the cathode current collector 22. One end of the cathode current collector 22 in a widthwise direction D2 includes a cathode uncoated portion 22A where the cathode mixture layer 23 is not formed such that the cathode current collector 22 is exposed.

The cathode current collector 22 is a foil of a metal such as aluminum or an alloy having aluminum as the main component. The cathode current collector 22 acts as a current collector of the cathode. In the roll, the opposing parts in the cathode uncoated portion 22A of the cathode current collector 22 are pressed together to form the cathode current collector portion 20A.

The cathode mixture layer 23 is formed by hardening a cathode mixture paste, which is in a liquid form. The cathode mixture paste includes a cathode active material, a cathode solvent, a cathode conductive material, and a cathode binder. The cathode mixture paste is dried and the cathode solvent is vaporized to form the cathode mixture layer 23. Accordingly, the cathode mixture layer 23 includes the cathode active material, the cathode conductive material, and the cathode binder.

The cathode active material may be a lithium-containing composite oxide that allows for the storage and release of lithium ions, which serve as the charge carrier of the lithium-ion rechargeable battery 10. A lithium-containing composite oxide may be an oxide containing lithium and a metal element other than lithium. The metal element other than lithium may be, for example, one selected from a group consisting of nickel, cobalt, manganese, vanadium, magnesium, molybdenum, niobium, titanium, tungsten, aluminum, and iron contained as iron phosphate in the lithium-containing composite oxide.

The lithium-containing composite oxide may be, for example, lithium cobalt oxide (LiCoO₂), lithium nickel oxide (LiNiO₂), or lithium manganese oxide (LiMn₂O₄). Further, the lithium-containing composite oxide may be, for example, a three-element lithium-containing composite oxide that contains nickel, cobalt, and manganese, that is, lithium nickel manganese cobalt oxide (LiNiCoMnO₂). The lithium-containing composite oxide may be, for example, lithium iron phosphate (LiFePO₄).

The cathode solvent may be an N-methyl-2-pyrrolidone (NMP) solution, which is an example of an organic solvent. The cathode conductive material may be, for example, carbon black such as acetylene black or ketjen black, carbon fibers such as carbon nanotubes or carbon nanofibers, or graphite. The cathode binder is an example of a resin component included in the cathode mixture paste. The cathode binder may be, for example, polyvinylidene fluoride (PVDF), polyvinyl alcohol (PVA), styrene-butadiene rubber (SBR), or the like.

The cathode sheet 21 may include an insulation layer at the boundary between the cathode uncoated portion 22A and the cathode mixture layer 23. The insulation layer includes an insulative inorganic component and a resin component that acts as a binder. The inorganic material may be at least one selected from a group consisting of boehmite, titania, and alumina that are in powder forms. The resin component may be at least one selected from a group consisting of PVDF, PVA, and acrylic.

### Anode Sheet 24

The anode sheet 24 includes an anode current collector 25 and an anode mixture layer 26. The anode current collector 25 is a strip of an anode substrate foil. The anode mixture layer 26 is applied to each of the opposing surfaces of the anode current collector 25. One end of the anode current collector 25 in the widthwise direction D2 at the side opposite the cathode uncoated portion 22A includes an anode uncoated portion 25A where the anode mixture layer 26 is not formed such that the anode current collector 25 is exposed.

The anode current collector 25 is a foil of a metal such as copper or an alloy having copper as the main component. The anode current collector 25 acts as a current collector of the anode. In the roll, the opposing parts in the anode uncoated portion 25A are pressed together to form the anode current collector portion 20B.

The anode mixture layer 26 is formed by hardening an anode mixture paste, which is in a liquid form. The anode mixture paste includes an anode active material, an anode solvent, an anode thickener, and an anode binder. The anode mixture paste is dried and the anode solvent is vaporized to form the anode mixture layer 26. Accordingly, the anode mixture layer 26 includes the anode active material and the additives of the anode thickener and the anode binder. The anode mixture layer 26 may further include an additive such as a conductive material.

The anode active material allows for the storage and release of lithium ions. The anode active material may be, for example, a carbon material such as graphite, hard carbon, soft carbon, carbon nanotubes, or the like. An example of the anode solvent is water. An example of the anode thickener may be carboxymethyl cellulose (CMC) as a thickener including sodium salts. The anode binder may use the same material as the cathode binder. An example of the anode binder may be styrene acrylate copolymer (SAR) as a binder including sodium salts.

### Separator 27

The separators 27 prevent contact between the cathode sheet 21 and the anode sheet 24 in addition to holding the non-aqueous electrolyte solution between the cathode sheet 21 and the anode sheet 24. Immersion of the electrode body 20 in the non-aqueous electrolyte solution results in the non-aqueous electrolyte solution permeating each separator 27 from the ends in the widthwise direction D2 toward the center.

Each separator 27 is a nonwoven fabric of polypropylene or the like. The separator 27 may be, for example, a porous polymer film such as a porous polyethylene film, a porous polyolefin film, a porous polyvinyl chloride film, or the like. Alternatively, the separator 27 may be an ion conductive polymer electrolyte film or the like.

### Non-Aqueous Electrolyte Solution

The non-aqueous electrolyte solution is a composition containing supporting salts in a non-aqueous solvent. The non-aqueous solvent may be one or two or more selected from a group consisting of propylene carbonate, ethylene carbonate, diethyl carbonate, dimethyl carbonate, ethyl methyl carbonate, and the like. The supporting salts may be a lithium compound (lithium salt) of one or two or more selected from a group consisting of LiPF₆, LiBF₄, LiCIO₄, LiAsF₆, LiCF₃SO₃, LiC₄F₉SO₃, LIN (CF₃SO₂)₂, LiC(CF₃SO₂)₃, LiI, lithium bis(oxalate) borate (LiBOB), and the like.

In the present embodiment, ethylene carbonate is used as the non-aqueous solvent. LiBOB, which is lithium salts serving as a film forming agent, is added to the non-aqueous electrolyte solution. For example, LiBOB is added to the non-aqueous electrolyte solution such that the concentration of LiBOB in the non-aqueous electrolyte solution is in a range of 0.001 mol/L to 0.1 mol/L.

### Manufacturing Method

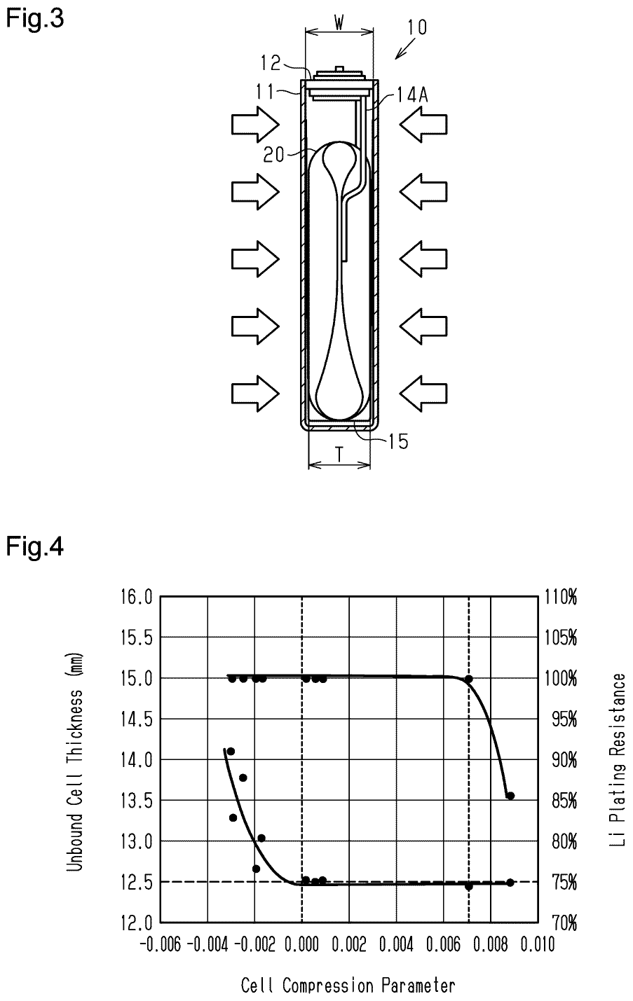

A method for manufacturing the lithium-ion rechargeable battery 10 will now be described with reference to FIGS. 3 and 4.

As shown in FIG. 3, when a thickness T of the electrode body 20 exceeds an inner dimension W of the battery case 11, the thickness of the battery cell expands. Accordingly, a cell compression parameter is set in a range of 0.000 to 0.007 so that the battery cell thickness will not expand. The cell compression parameter is obtained by dividing a cell compression force by a cell spring constant. The cell spring constant is calculated from a changed amount of the battery cell thickness when the battery cell is compressed from 2 kN to 5 kN by AUTOGRAPH (precision universal testing device, registered trademark of Shimadzu Corporation). The cell compression parameter is expressed by Equation (1). The cell compression force is obtained by multiplying a difference of the internal pressure of the battery case 11 relative to the atmospheric pressure by an area of a flat portion of the electrode body 20. The cell compression force is expressed by Equation (2). The area of the flat portion of the electrode body 20 is obtained by multiplying a width of the applied cathode and a length of the flat portion of the electrode body 20. The area of the flat portion of the electrode body 20 is expressed by Equation (3). The length of the flat portion of the electrode body 20 is, for example, the innermost length of the cathode in the electrode body 20 in the longitudinal direction D1 (innermost cathode length).

Cell compression parameter=cell compression force/cell spring constant (kN/mm) Equation (1)

Cell compressive force=−cell internal pressure (MPa)×area of flat portion of electrode body (mm₂) Equation (2)

Area of flat portion of electrode body=width of applied cathode (mm)×length of flat portion of electrode body (mm) Equation (3)

As shown in FIG. 4, when the cell compression parameter is in a range greater than 0.000, the cell compression force resulting from the atmospheric pressure acts to restrict expansion of the cell thickness in an unbound state. The cell thickness in an unbound state corresponds to a thickness measured by contacting a measuring element of Digimatic Indicator (manufactured by Mitsutoyo Corporation, pressing at 1.5 N, for example) to the most projected portion on the side surface of the battery cell. The cell thickness in a non-expanded state is a sum of the wall thickness of the battery case 11 (two sides), the thickness of the outer insertion film 15 (two sides), and the thickness of the electrode body 20 (refer to FIG. 3).

Further, when the cell internal pressure is decreased and the cell compression parameter becomes greater than or equal to 0.007, the depressurized cell adversely affects the efficiency of impregnation of the electrode body 20 with the electrolyte solution. When the impregnation efficiency of the electrolyte solution is lowered, film formation on the anode may become uneven. Thus, the cell may become less resistant to lithium (Li) plating. A Li plating resistance is an index of the Li plating resistance of each battery cell with respect to a Li plating limit current value of 100 when the cell compression parameter is 0.000.

Thus, when the cell compression parameter is set in a range of 0.000 to 0.007, the cell thickness in an unbound state will be stable, and the Li plating resistance will not be decreased by the depressurized cell.

The present embodiment has the following advantages.

(1) When the cell compression parameter is greater than or equal to 0.000, the cell compression force resulting from the atmospheric pressure acts to restrict expansion of the cell thickness in an unbound state. Further, when the cell compression parameter is less than or equal to 0.007, the impregnation efficiency of the electrode body 20 with the electrolyte solution will not be lowered by the depressurized cell.

### Other Embodiments

The above embodiment may be modified as described below. The above embodiment and the following modifications can be combined as long as the combined modifications remain technically consistent with each other.

In the above embodiment, the cell spring constant may be decreased by increasing the number of the separators.

In the above embodiment, the opening of the battery case 11 may be sealed with the lid 12 immediately after the electrolytic solution is injected into the battery case 11 such that the pressure inside the battery cell becomes negative. Alternatively, a gap between the electrode body 20 in the battery case 11 and the lid 12 may be increased so that the impregnation of the electrode body 20 with the electrolytic solution causes the pressure inside the battery cell to become negative.

In the above embodiment, the electrode body 20 is a roll formed by rolling a stack of the cathode sheet 21, the anode sheet 24, and the separators 27. However, the electrode body may be a stack of cathode sheets 21 and anode sheets 24 that are alternately stacked with a separator 27 arranged in between.

The lithium-ion rechargeable battery 10 may be used in an automatic transporting vehicle, a special hauling vehicle, a battery electric vehicle, a hybrid electric vehicle, a computer, an electronic device, or any other system. For example, the lithium-ion rechargeable battery 10 may be used in a marine vessel, an aircraft, or any other type of movable body. The lithium-ion rechargeable battery 10 may also be used in a system that supplies electric power from a power plant via a substation to buildings and households.

### EXAMPLES

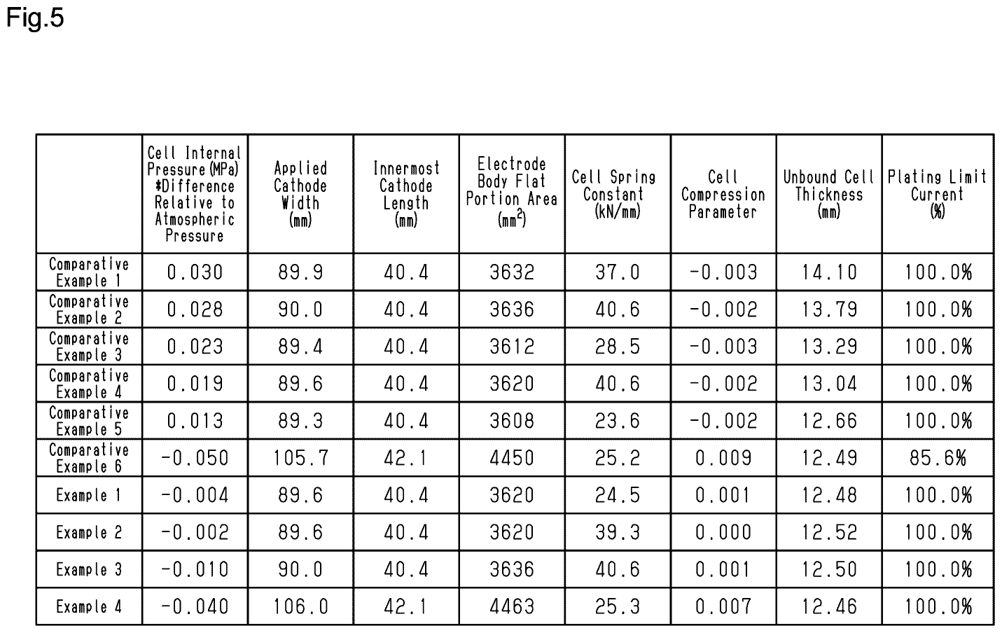

Examples and comparative examples of the lithium-ion rechargeable battery 10 will now be described with reference to FIG. 5. The examples and comparative examples are not intended to limit the method for manufacturing a non-aqueous rechargeable battery.

As shown in FIG. 5, examples and comparative examples of lithium-ion rechargeable batteries 10 were prepared having different combinations of cell internal pressure, applied cathode width, innermost cathode length, and cell spring constant. Then, the cell compression parameter was calculated for each example and comparative example to evaluate the unbound cell thickness (mm) and the plating limit current (%).

### Comparative Example 1

The cell internal pressure was 0.030 MPa, which was greater than the atmospheric pressure. The area of the flat portion of the electrode body 20 was 3632 mm². The cell spring constant was 37.0 kN/mm. The cell compression parameter was −0.003.

### Comparative Example 2

The cell internal pressure was 0.028 MPa, which was greater than the atmospheric pressure. The area of the flat portion of the electrode body 20 was 3636 mm². The cell spring constant was 40.6 kN/mm. The cell compression parameter was −0.002.

### Comparative Example 3

The cell internal pressure was 0.023 MPa, which was greater than the atmospheric pressure. The area of the flat portion of the electrode body 20 was 3612 mm². The cell spring constant was 28.5 kN/mm. The cell compression parameter was −0.003.

### Comparative Example 4

The cell internal pressure was 0.019 MPa, which was greater than the atmospheric pressure. The area of the flat portion of the electrode body 20 was 3620 mm². The cell spring constant was 40.6 kN/mm. The cell compression parameter was −0.002.

### Comparative Example 5

The cell internal pressure was 0.013 MPa, which was greater than the atmospheric pressure. The area of the flat portion of the electrode body 20 was 3608 mm². The cell spring constant was 23.6 kN/mm. The cell compression parameter was −0.002.

### Comparative Example 6

The cell internal pressure was −0.050 MPa, which was less than the atmospheric pressure. The area of the flat portion of the electrode body 20 was 4450 mm². The cell spring constant was 25.2 kN/mm. The cell compression parameter was 0.009.

### Example 1

The cell internal pressure was −0.004 MPa, which was less than the atmospheric pressure. The area of the flat portion of the electrode body 20 was 3620 mm². The cell spring constant was 24.5 kN/mm. The cell compression parameter was 0.001.

### Example 2

The cell internal pressure was −0.002 MPa, which was less than the atmospheric pressure. The area of the flat portion of the electrode body 20 was 3620 mm². The cell spring constant was 39.3 kN/mm. The cell compression parameter was 0.000.

### Example 3

The cell internal pressure was −0.010 MPa, which was less than the atmospheric pressure. The area of the flat portion of the electrode body 20 was 3636 mm². The cell spring constant was 40.6 kN/mm. The cell compression parameter was 0.001.

### Example 4

The cell internal pressure was −0.040 MPa, which was less than the atmospheric pressure. The area of the flat portion of the electrode body 20 was 4463 mm². The cell spring constant was 25.3 kN/mm. The cell compression parameter was 0.007.

### Evaluations

The unbound cell thickness (mm) and the plating limit current (%) were evaluated for each example and comparative example. The cell thickness (mm) in a non-expanded state is 12.50 mm.

In Comparative Examples 1 to 5 in which the cell internal pressure was greater than the atmospheric pressure, the unbound cell thickness was greater than 12.50 mm. On the other hand, in Comparative Example 6 and Examples 1 to 4 in which the cell internal pressure was less than the atmospheric pressure, the unbound cell thickness was less than or equal to approximately 12.50 mm. Therefore, it is preferred that the cell internal pressure be less than the atmospheric pressure and that the cell compression parameter be greater than or equal to 0.000.

In Comparative Examples 1 to 5 and Examples 1 to 4 in which the cell compression parameter was less than or equal to 0.007, the plating limit current was 100.0%. In Comparative Example 6 in which the cell compression parameter was 0.009 and greater than 0.007, the plating limit current was 85.6%. Therefore, it is preferred that the cell compression parameter be less than or equal to 0.007. Examples 1 to 4 had superior results.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A non-aqueous rechargeable battery, comprising:
an electrode body in which a cathode sheet and an anode sheet are stacked with a separator arranged in between;
a non-aqueous electrolyte solution; and
a case accommodating the electrode body and the non-aqueous electrolyte solution,
wherein a cell compression parameter obtained by dividing a cell compression force, obtained by multiplying a difference of an internal pressure of the case relative to an atmospheric pressure by an area of a flat portion of the electrode body, by a spring constant of the case is in a range of 0.000 to 0.007.

2. A method for manufacturing a non-aqueous rechargeable battery, the non-aqueous rechargeable battery including an electrode body in which a cathode sheet and an anode sheet are stacked with a separator arranged in between, a non-aqueous electrolyte solution, and a case accommodating the electrode body and the non-aqueous electrolyte solution, the method comprising:
adjusting a cell compression parameter obtained by dividing a cell compression force, obtained by multiplying a difference of an internal pressure of the case relative to an atmospheric pressure by an area of a flat portion of the electrode body, by a spring constant of the case in a range of 0.000 to 0.007.
